(19) United States
(12) Patent Application Publication
(10) Pub. No.: US 2025/0327336 A1
(43) Pub. Date: Oct. 23, 2025

(54) Driving Device For Electronic Locks

(71) Applicant: Zhiquan Wang, Zhangshu (CN)

(72) Inventor: Zhiquan Wang, Zhangshu (CN)

(21) Appl. No.: 18/641,331

(22) Filed: Apr. 20, 2024

(51) Int. Cl. E05B 47/00

(52) U.S. Cl. CPC E05B 47/0012; E05B 47/0603; E05C 3/24; E05B 2047/0017

(57) ABSTRACT

A driving device for electronic locks is disclosed, including an upper base, a bolt arranged in the upper base, and a slide block slidably disposed in the upper base. The upper base is fixedly provided with a fixed shaft, the bolt is rotationally connected to the fixed shaft, and the fixed shaft is sleeved with a torsional spring for driving a rotation of the bolt. One end of the slide block is fixedly provided with a baffle for restricting the rotation of the bolt, the lower base inside is fixedly provided with a motor, and an output end of the motor is fixedly provided with an eccentric shaft for driving the slide block to slide. The driving device has a simple structure, and its driving effect is reliable and the friction is small, which can reduce the consumption of electric power and less noise, thereby improving stability when in use.

### TECHNICAL FIELD

The present application relates to the technical field of locks, and in particular to a driving device for electronic locks.

### BACKGROUND

With development of society, electronic locks are more and more popular, and the electronic locks have a variety of types. In current competitive market, stability, sensitivity and energy saving durability of the electronic locks have become the focus of research by various manufacturers. However, a clutch control mechanism of most of current electronic locks generally uses a gear reducer micro-motor driving device to push a clutch pin to do mechanism separation or closure mechanical motion, to control the mode of a motor switch to control the control mechanism of the electronic lock for opening and closing, and there are a number of travel switch are adopted to control, but their structures are relatively complex.

Such driving device in traditional electronic locks will generate frictions due to mutual coincidence between gear sets and changes of circular rotation to linear motion, which greatly depletes electrical energy and motor torque, not only leading to batteries of the electronic locks have a short limited service life and easy to generate noise, but also easy to cause wear and tear of the micro-motor gear set and instability of the driving device of the electronic locks. In order to solve above problems, the present disclosure propose a driving device for electronic locks.

### SUMMARY

The present disclosure aims to provide a driving device for electronic locks to address problems that high friction and loss of power in driving mode of existing technologies, as well as easy to generate noise and instability of the driving device.

To achieve above objectives, the present disclosure adopts following technical solutions. In some embodiments of the present disclosure, a driving device for electronic locks is provided, including an upper base, and the upper base is removably provided with a lower base at a bottom thereon. Moreover, the driving device for electronic locks further includes, a bolt arranged in the upper base, herein the upper base is fixedly provided with a fixed shaft, the bolt is rotationally connected to the fixed shaft, and the fixed shaft is sleeved with a torsional spring for driving a rotation of the bolt; and a slide block slidably disposed in the upper base, herein one end of the slide block is fixedly provided with a baffle for restricting the rotation of the bolt, the lower base inside is fixedly provided with a motor, and an output end of the motor is fixedly provided with an eccentric shaft for driving the slide block to slide.

In order to facilitate driving the slide block to reset, preferably, the other end of the slide block is fixedly provided with a connecting rod, the connecting rod is sleeved with a spring, and both ends of the spring are against the slide block and the upper base respectively.

In order to ensure that the slide block slides reliably, preferably, the upper base inside is fixedly provided with a limited rod, the slide block is opened with a kidney slot, the limited rod is slidably connected into the kidney slot, and an outer wall of the limited rod is tangent to an inner wall of both sides of the kidney slot respectively.

In order to facilitate the eccentric shaft to drive the slide block to slide in a reverse direction, preferably, the slide block is opened with a drive groove at an end face thereon near the baffle, and a circumference of the eccentric shaft is against a side wall of the drive groove.

Preferably, the baffle is fixedly provided with a limit plate at a bottom thereon, and a side wall of the limit plate is against the circumference of the eccentric shaft.

Preferably, the upper base is opened with a plug-in trough, and the bolt is opened with a locking groove at one end located in the plug-in trough.

Preferably, the upper base is opened with a limit slot connected with the plug-in trough and the limit slot inside is fixedly provided with an inclined plane, an outer wall of the locking groove is against the inclined plane, the other end of the bolt is fixedly provided with an extension block, and a bottom of the extension block is against a top of the baffle.

Preferably, the slide block is fixedly provided with a push rod.

Compared with the existing technologies, the driving device for electronic locks of the present disclosure has at least following beneficial effects and advantages.
1. The driving device for electronic locks of the present disclosure, by fixedly providing the eccentric shaft at the output end of the motor, when the motor drives the eccentric shaft to rotate and the circumference of the eccentric shaft is against the side wall of the drive groove at this time, the slide block can be driven away from the bolt, realizing unlocking of the lock. Moreover, the driving device has a simple structure, and its driving effect is reliable and the friction is small, which can reduce the consumption of electric power and less noise, thereby improving stability when in use.
2. The driving device for electronic locks of the present disclosure, by opening the kidney slot on the slide block and fixedly disposing the limited rod in the upper base, on the one hand, the slide block can be ensured to slide reliably, preventing deflection and affecting normal use. On the other hand, it can also be limited to the slide block, avoiding too much sliding in the direction of the bolt.

Other parts not related of the driving device for electronic locks of the present disclosure are the same as the existing technologies, or may be realized by using the existing technologies. The driving device for electronic locks of the present disclosure, by fixedly providing the eccentric shaft at the output end of the motor, when the motor drives the eccentric shaft to rotate, the slide block can be driven away from the bolt, realizing unlocking of the lock. Moreover, the driving device has a simple structure, and its driving effect is reliable and the friction is small, which can reduce the consumption of electric power and less noise, thereby improving the stability when in use.

### BRIEF DESCRIPTION OF THE DRAWINGS

FIG. 1 shows a structural schematic diagram of a driving device for electronic locks in accordance with some embodiments of the present disclosure.

FIG. 2 shows a structural schematic diagram of a slide block of the driving device for electronic locks in accordance with some embodiments of the present disclosure.

FIG. 3 shows a structural schematic diagram of the driving device for electronic locks in a locked state in accordance with some embodiments of the present disclosure.

FIG. 4 shows a structural schematic diagram of the driving device for electronic locks in an unlocked state in accordance with some embodiments of the present disclosure.

In the drawings, reference signs are as follows. 1. Upper base, 101. Lower base, 102. Plug-in trough, 103. Limit slot, 104. Limited rod, 105. Inclined plane, 106. Fixed shaft, 2. Bolt, 201. Locking groove, 202. Extension block, 3. Slide block, 301. Drive groove, 302. Limit plate, 303. Push rod, 304. Connecting rod, 305. Kidney slot, 306. Baffle, 4. Motor, 401. Eccentric shaft.

### DETAILED DESCRIPTION OF THE EMBODIMENTS

The technical solutions in embodiments of the present disclosure will be clearly and completely described below in conjunction with accompanying drawings in the embodiments of the present disclosure. Obviously, described embodiments are only a part of the embodiments of the present disclosure and not all of the embodiments of the present disclosure.

In the description of the present disclosure, it should be understood that terms “up”, “down”, “front”, “back”, “left”, “right”, “top”, “bottom”, “inside”, “outside”, and the like indicating orientation or positional relationships are based on those shown in the accompanying drawings, and are intended only for the purpose of facilitating the description of the present disclosure and simplifying the description, and are not intended to indicate or imply that a device or an element referred to must have a particular orientation, be constructed and operated in a particular orientation, and therefore is not to be construed as a limitation of the present invention.

### EMBODIMENTS

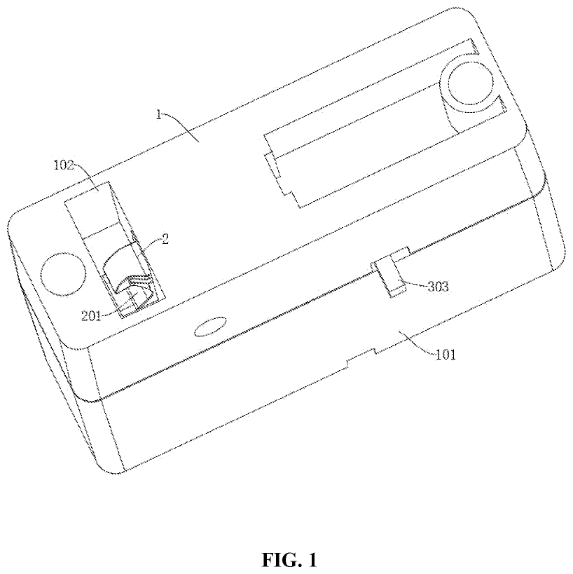

Referring to FIG. 1 to FIG. 4, in some embodiments of the present disclosure, a driving device for electronic locks is provided, including an upper base 1 and the upper base 1 is removably provided with a lower base 101 at a bottom thereon. The lower base 101 can be secured to the upper base 1 by means of clips or screws, etc., preferably the screws. Moreover, the driving device for electronic locks further includes a bolt 2 arranged in the upper base 1. Herein the upper base 1 is fixedly provided with a fixed shaft 106, the bolt 2 is rotationally connected to the fixed shaft 106, and the fixed shaft 106 is sleeved with a torsional spring for driving a rotation of the bolt 2. A side wall of the bolt 2 and an inner wall of the limit slot 103 each is provided with a clamping slot, and both ends of the torsional spring are respectively clamped into corresponding clamping slot. When in use, under an action of an elastic force of the torsional spring, the bolt 2 can be kept in an unlocked state or the bolt 2 can have a tendency to be unlocked. In addition, the driving device for electronic locks further includes a slide block 3 slidably disposed in the upper base 1. Herein one end of the slide block 3 is fixedly provided with a baffle 306 for restricting the rotation of the bolt 2, when the baffle 306 is against the blot 2, it can limit the rotation of the bolt 2 and bring the bolt 2 in a locked state. The lower base 101 inside is fixedly provided with a motor 4, and an output end of the motor 4 is fixedly provided with an eccentric shaft 401 for driving the slide block 3 to slide. By driving the eccentric shaft 401 via the motor 4 to rotate, the slide block 3 can be driven away from the bolt 2 to realize the unlocking. And a push rod 303 is fixedly provided on the slide block 3, one end of the push rod 303 which is away from the slide block 3 extends to the outer side of the upper base 1, so that the unlocking can be realized by a manual way to improve the effect of use.

When in use, by fixedly setting the eccentric shaft 401 at an output end of the motor 4, the motor 4 drives the eccentric shaft 401 to rotate, and at the same time, a circumference of the eccentric shaft 401 is against a side wall of the drive groove 301, which can drive the slide block 3 away from the bolt 2, realizing the unlocking of the lock. And the driving device has a simple structure, its driving effect is reliable and the friction is small, so that it can reduce the consumption of power, and the noise is also small, which can help to improve the stability in use.

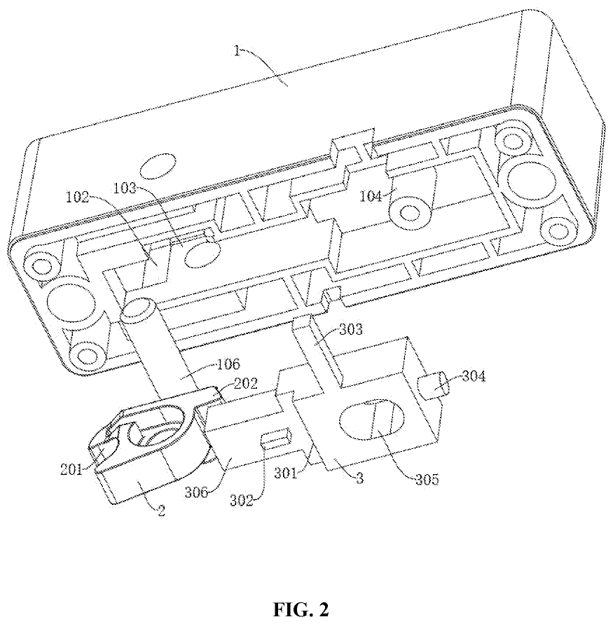

Referring to FIG. 2 to FIG. 4, the other end of the slide block 3 is fixedly provided with a connecting rod 304, the connecting rod 304 is sleeved with a spring, and both ends of the spring are against the slide block 3 and the upper base 1 respectively. When in use, by setting the spring at the other end of the slide block 3, on the one hand, it is convenient to drive the slide block 3 for resetting when the motor 4 stops driving the eccentric shaft 401 to rotate, and on the other hand, in the absence of an external force, it is possible to keep the baffle 306 in a state of limitation for the extension block 202 at all times to ensure the reliability of the bolt 2 in the locked state.

Referring to FIG. 2 to FIG. 4, the upper base 1 inside is fixedly provided with a limited rod 104, the slide block 3 is opened with a kidney slot 305, and a direction of a long axis of the kidney slot 305 is parallel to a sliding direction of the slide block 3. The limited rod 104 is slidably connected into the kidney slot 305, and an outer wall of the limited rod 104 is tangent to an inner wall of both sides of the kidney slot 305 respectively. When in use, by setting the kidney slot 305 on the slide block 3 and fixedly setting the limited rod 104 in the upper base 1, on the one hand, the slide block 3 can be ensured to slide reliably, preventing occurrence of skewing and affecting normal use. And on the other hand, it can also be limited to the slide block 3, avoiding excessive sliding toward the direction of the bolt 2.

Referring to FIG. 2 to FIG. 4, the slide block 3 is opened with a drive groove 301 at an end face near the baffle 306, and the circumference of the eccentric shaft 401 is against the side wall of the drive groove 301. When in use, the eccentric shaft 401 is driven to rotate by the motor 4, the eccentric shaft 401 is against the side wall of the drive groove 301, which can drive the slide block 3 away from the bolt 2, thereby realizing unlocking.

Referring to FIG. 2 to FIG. 4, the baffle 306 is fixedly provided with a limit plate 302 at a bottom thereon, and a side wall of the limit plate 302 is against the circumference of the eccentric shaft 401. When in use, by setting the limit plate 302, a rotation angle of the eccentric shaft 401 can be limited, so that its rotation range is less than 360°. When unlocking the lock, firstly the motor 4 is started to drive the eccentric shaft 401 from the side of the limit plate 302 to the other side of the rotation process, and the eccentric shaft 401 can push the slide block 3 to move in an opposite direction in a middle of this movement, that is to say, away from the direction of the bolt 2, until the bolt 2 is out of the limitation of the baffle 306, the bolt 2 is subjected to the elasticity of the torsional spring to rotate clockwise, to complete unlocking of the lock. At this time, when the eccentric shaft 401 pushes the slide block 3 to the limit position in the opposite direction, the eccentric shaft 401 continues to rotate, and then the slide block 3 is reset under the push of the spring. Meanwhile, the motor 4 drives the eccentric shaft 401 to rotate to the other side of the limit plate 302 and when it touches the limit plate 302, an electronic control unit senses the change of voltage in the motor 4 and immediately controls the motor 4 to rotate inversely by 30° and then stops, herein the electronic control unit adopts the existing technologies and completes a complete unlocking action. And when unlocking the lock for the next time, the eccentric shaft 401 rotates from a current side of the limit plate 302 to the other side thereof, and the above operations are repeated.

Referring to FIG. 1 to FIG. 4, the upper base 1 is opened with a plug-in trough 102, and the bolt 2 is opened with a locking groove 201 at one end located in the plug-in trough 102. And when the bolt 2 is in the unlocked state, the locking groove 201 opens upwards and locates inside the plug-in trough 102, making it easy to use next time.

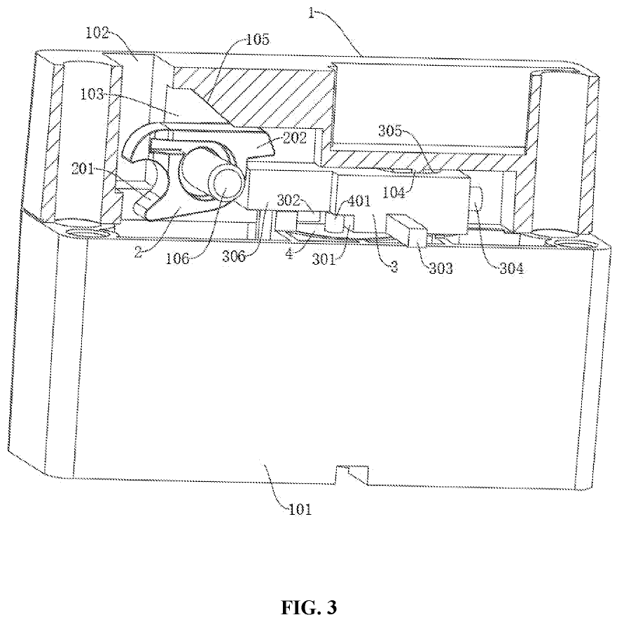

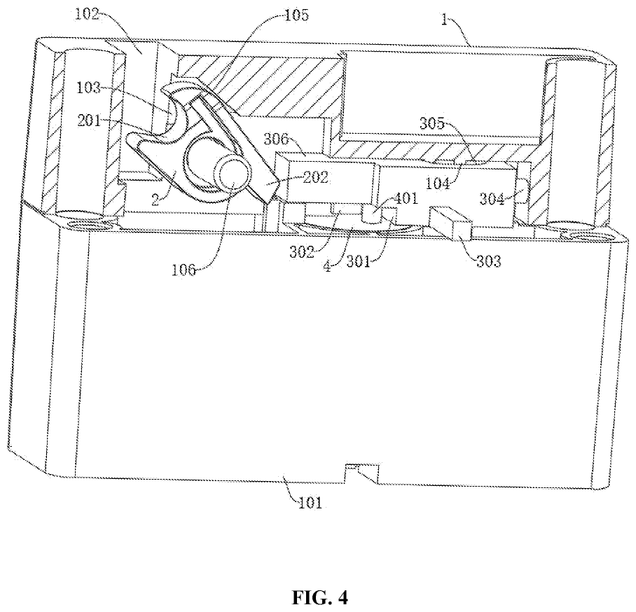

Referring to FIG. 3 and FIG. 4, the upper base 1 is opened with a limit slot 103 connected with the plug-in trough 102 and the limit slot 103 inside is fixedly provided with an inclined plane 105, an outer wall of the locking groove 201 is against the inclined plane 105, which can prevent excessive rotation angle of the bolt 2 under the action of the torsional spring. And the other end of the bolt 2 is fixedly provided with an extension block 202, and a bottom of the extension block 202 is against a top of the baffle 306. When in use, by pushing the bolt 2 to rotate, and when the bolt 2 is rotating, the extension block 202 can push the slide block 3 to move in the opposite direction, until the baffle 306 is detached from the push with the extension block 202, then the slide block 3 is immediately reset by the pressure of the spring, and the baffle 306 snaps the extension block 202, so that the bolt 2 is in the locked state, and completes the locking of the lock.

The foregoing description is only some better specific implementations of the present disclosure, but the scope of protection of the present disclosure is not limited thereto, any skilled person in the art familiar with the technical field within the technical scope of the present disclosure, by making equivalent substitutions or changes in accordance with the technical solution and concept of the present disclosure, shall be covered by the scope of protection of the present invention.

What is claimed is:

1. A driving device for electronic locks, comprising an upper base (1), and the upper base (1) is removably provided with a lower base (101) at a bottom thereon;
wherein the driving device for electronic locks further comprises
a bolt (2) arranged in the upper base (1), wherein the upper base (1) is fixedly provided with a fixed shaft (106), the bolt (2) is rotationally connected to the fixed shaft (106), and the fixed shaft (106) is sleeved with a torsional spring for driving a rotation of the bolt (2); and
a slide block (3) slidably disposed in the upper base (1), wherein one end of the slide block (3) is fixedly provided with a baffle (306) for restricting the rotation of the bolt (2), the lower base (101) inside is fixedly provided with a motor (4), and an output end of the motor (4) is fixedly provided with an eccentric shaft (401) for driving the slide block (3) to slide.

2. The driving device for electronic locks according to claim 1, wherein the other end of the slide block (3) is fixedly provided with a connecting rod (304), the connecting rod (304) is sleeved with a spring, and both ends of the spring are against the slide block (3) and the upper base (1) respectively.

3. The driving device for electronic locks according to claim 1, wherein the upper base (1) inside is fixedly provided with a limited rod (104), the slide block (3) is opened with a kidney slot (305), the limited rod (104) is slidably connected into the kidney slot (305), and an outer wall of the limited rod (104) is tangent to an inner wall of both sides of the kidney slot (305) respectively.

4. The driving device for electronic locks according to claim 1, wherein the slide block (3) is opened with a drive groove (301) at an end face thereon near the baffle (306), and a circumference of the eccentric shaft (401) is against a side wall of the drive groove (301).

5. The driving device for electronic locks according to claim 4, wherein the baffle (306) is fixedly provided with a limit plate (302) at a bottom thereon, and a side wall of the limit plate (302) is against the circumference of the eccentric shaft (401).

6. The driving device for electronic locks according to claim 1, wherein the upper base (1) is opened with a plug-in trough (102), and the bolt (2) is opened with a locking groove (201) at one end located in the plug-in trough (102).

7. The driving device for electronic locks according to claim 6, wherein the upper base (1) is opened with a limit slot (103) connected with the plug-in trough (102) and the limit slot (103) inside is fixedly provided with an inclined plane (105), an outer wall of the locking groove (201) is against the inclined plane (105), the other end of the bolt (2) is fixedly provided with an extension block (202), and a bottom of the extension block (202) is against a top of the baffle (306).

8. The driving device for electronic locks according to claim 1, wherein the slide block (3) is fixedly provided with a push rod (303).
